(19) United States
(12) Patent Application Publication
(10) Pub. No.: US 2003/0102039 A1
(43) Pub. Date: Jun. 5, 2003

(54) Electrovalve for irrigation with a rapid and simplified assembly

(76) Inventor: Laura Marzorati, Duno (IT)

Correspondence Address: James V. Costigan, Esq., Hedman & Costigan, P.C., Suite 2003, 1185 Avenue of the Americas, New York, NY, 10036-2646, US

(21) Appl. No.: 10/304,655

(22) Filed: Nov. 26, 2002

(30) Foreign Application Priority Data
Dec. 5, 2001 (IT) MI2001U 000637

(51) Int. Cl. F16K 1/00

(52) U.S. Cl. 137/883

(57) ABSTRACT

An electrovalve for irrigation with a rapid and simplified assembly, comprising a body and ends connected to a collector (12) and to a joint (13) wherein the electrovalve comprises, at both sides facing the collector (12) and the joint (13), a ferrule coupling (17, 19) with threaded portions of the ends (22, 15), there also being, inside the ferrule (17, 19), a head sealing O-ring (21).

The present invention relates to an electrovalve for irrigation, with a rapid and simplified assembly.

In the field of irrigation, the various distribution pipes of water or similar irrigation liquid, are connected to electrovalves in turn connected to appropriate collectors.

The collectors can have directly pre-assembled electrovalves which are subsequently connected, by means of suitable screw-joints, to the ends of distribution pipes.

This arrangement makes it impossible to remove the electrovalve without having to turn the compression joint on the pipe, removing it from the pipe.

Alternatively, a part of the pipe must be cut, by lifting the electrovalve and relative compression joint attached to the pipe. This operation is particularly tiring and it is then necessary to rotate the electrovalve to unscrew it.

In another known alternative, a connection nipple with the compression joint is used, to allow the electrovalve to be unscrewed without having to rotate the pipe.

Furthermore, in order to effect these operations, it is generally necessary to use suitable equipment. There are in fact devices for tightening the parts together, after arranging sealing tapes or the like on the threads of the electrovalve or compression joint.

All of this undoubtedly creates considerable problems for the operator and is also time-consuming. It is also necessary, moreover, to substitute possible pipes which have become too short as a result of the cuts made during the interventions described above.

An objective of the present invention is to produce an electrovalve for irrigation with a rapid and simplified assembly which solves all this series of problems and drawbacks.

A further objective of the present invention is to produce an electrovalve which avoids the use of any particular tool.

Yet another objective is to accelerate both assembly and maintenance operations, minimizing the relative costs.

These objectives according to the present invention are achieved by the production of an electrovalve for irrigation with a rapid and simplified assembly, as specified in claim 1.

The subsequent claims define the additional characteristics of the present invention.

The characteristics and advantages of an electrovalve for irrigation with a rapid and simplified assembly, according to the present invention, will become more evident from the following, illustrative but non-limiting, description, referring to the schematic drawings enclosed in which:

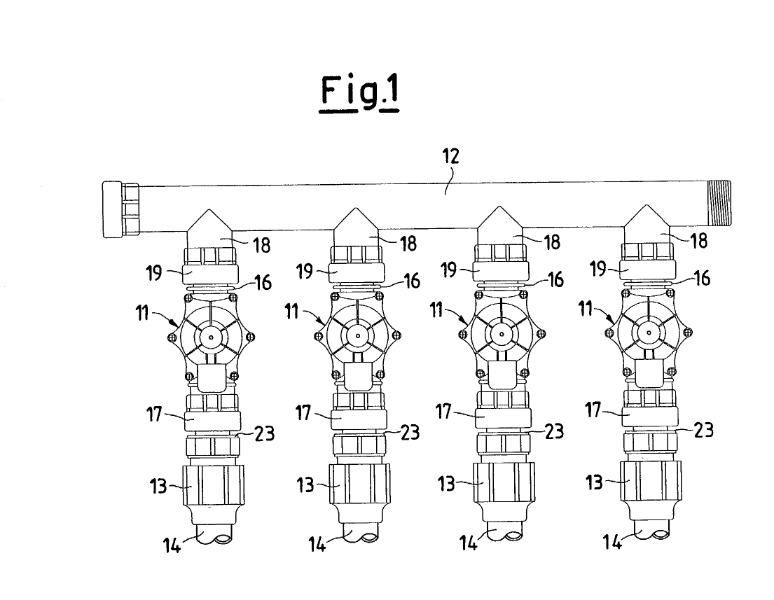

FIG. 1 is a plan view from above of four electrovalves according to the invention, connected to a collector and relative joints situated at the ends of pipes, partially shown,

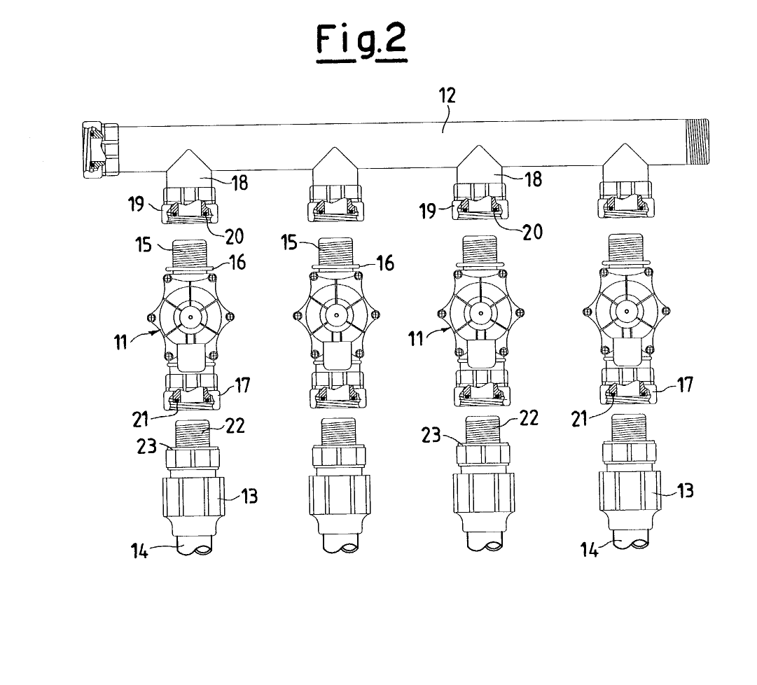

FIG. 2 is an exploded view of the parts illustrated in FIG. 1, once the ferrules have been unscrewed, and partially sectioned, showing the sealing O-ring inserted at the head,

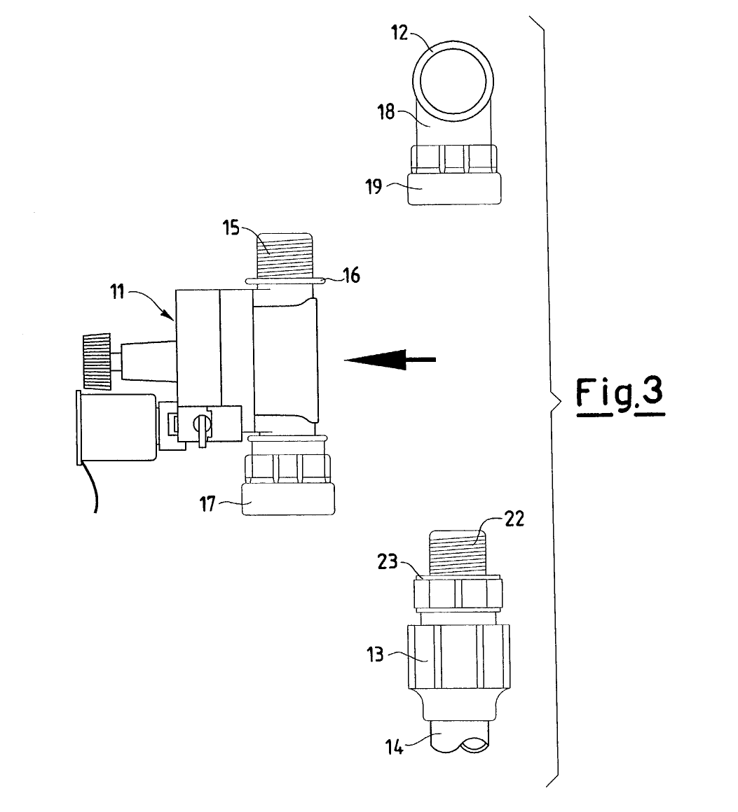

FIG. 3 is a raised side view of one of the electrovalves shown in FIG. 2 when it is extracted by means of simple vertical lifting, without moving any of the remaining parts of the arrangement illustrated,

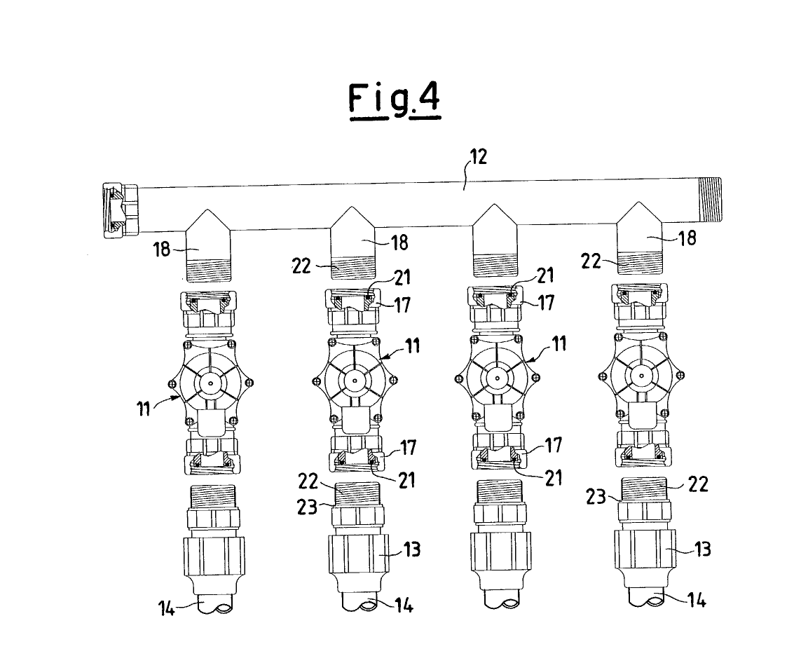

FIG. 4 is an exploded view of the parts shown in a further illustration, once the ferrules have been unscrewed, partially sectioned, showing the sealing O-ring inserted at the head.

With reference to the figures, these illustrate an electrovalve for irrigation with a rapid and simplified assembly, indicated as a whole with 11, once coupled and connected to a collector 12 and to the respective joints 13 situated at the ends of pipes 14, partially shown.

Said electrovalve 11, shown in the non-limiting example, comprises, at the inlet and outlet ends of its body, on one side, a threaded portion 15, with a sealing flange 16, and on the other side, a ferrule 17, internally threaded, axially moveable with respect to the end of the body of the electrovalve and which can rotate around said axis.

In this way, the electrovalve 11, according to the present invention, can be rapidly connected to both the collector 12 and respective joints 13. Outlets 18 of the collector 12 are, in fact, also equipped with analogous ferrules 19. These ferrules 19 are also internally threaded, are moveable with respect to the end of the body of the collector 12 on the axes of the respective outlets and can rotate around these axes. The ferrules 19 are therefore arranged on the threads 15 and a respective sealing O-ring 20, internal and partially illustrated, ensures a stable and safe seal between the parts.

The ferrule 17 of each electrovalve 11 is also arranged with its sealing O-ring 21 on the threaded portion 22, with a sealing flange 23, creating a stable and safe seal.

This operation, as clearly shown in FIGS. 2 and 3, is effected without moving either the collector 12 or the joints 13 and pipes 14.

It is sufficient, in fact, to rotate the ferrules 19 on one side and the ferrules 17 on the other, after simply keeping the parts aligned.

In this way, it is no longer necessary to use sealing tape on the threads 22 of the starting male compression joint 13 thanks to the head sealing O-ring 21 on the pre-assembled ferrule 17.

FIG. 3 shows how, in order to remove the electrovalve 11, it is only necessary to unscrew the pre-assembled ferrule 17, which, on turning in neutral, allows the electrovalve 11 itself to be removed without having to act on the compression joint 13.

With respect to the other side of the electrovalve 11, it is sufficient to unscrew the pre-assembled ferrule 19 of the collector 12, which, on turning in neutral and withdrawing onto the outlet 18 of the collector 12, also allows the second side to be removed.

In these assembly and/or dismantling operations, it is not necessary to use any type of equipment for fixing the electrovalve 11 to the starting compression joint 13 of the pipe 14.

Furthermore, the thread of the pre-assembled female ferrule 17 is standard and compatible with all compression joints 13 present on the market.

Equivalently and with the same innovative principle, the electrovalve of the present invention can evidently comprise, at its two ends, a pair of ferrules, as shown in FIG. 4, or much more simply, a pair of threads suitable for being coupled with other complementary elements situated on the collector and/or respective joints.

Numerous modifications and variations can be applied to an electrovalve for irrigation with a rapid and simplified assembly thus conceived, all included in the present invention; all the details, moreover, can be substituted with technically equivalent elements. In practice, the materials and dimensions used can vary according to the technical demands.

1. An electrovalve for irrigation with a rapid and simplified assembly, comprising a body and ends connected to a collector (12) and to a joint (13) characterized in that it comprises, at both sides facing the collector (12) and said joint (13), a ferrule coupling (17, 19) with threaded portions of the ends (22, 15), there also being, inside said ferrule (17, 19), a head sealing O-ring (21).

2. The electrovalve according to claim 1, characterized in that it comprises, at the end facing said collector (12), a threaded end (15) and, at the other end, a ferrule (17) with an internal head sealing O-ring (21).

3. The electrovalve according to claim 1, characterized in that said threaded end (15) has a sealing flange (16) for said head sealing O-ring (21).

4. The electrovalve according to claim 1, characterized in that it comprises threaded ends (15), on both sides, said joint and said collector having respective ferrules (19).
